(19) United States
(12) Patent Application Publication
(10) Pub. No.: US 2021/0033752 A1
(43) Pub. Date: Feb. 4, 2021

(54) THIN FILM OPTICAL LENS DEVICE

(71) Applicant: inFilm Optoelectronic Inc., Grand Cayman (KY)

(72) Inventor: Chih-Hsiung LIN, Grand Cayman (KY)

(73) Assignee: inFilm Optoelectronic Inc., Grand Cayman (KY)

(21) Appl. No.: 16/899,139

(22) Filed: Jun. 11, 2020

(30) Foreign Application Priority Data
Jul. 29, 2019 (CN) 201910689472.5
Oct. 17, 2019 (TW) 108137565

(51) Int. Cl. G02B 3/00; G02B 7/09

(52) U.S. Cl. CPC G02B 3/0062; G02B 7/09

(57) ABSTRACT

A thin film optical lens device includes a first light-permissive film and a second light-permissive film. The first light-permissive includes first micro-lenses, a first light incident surface, and a first light illuminating surface opposite to the first light incident surface. The first micro-lenses are two-dimensionally arranged to form a first micro-lens array. The second light-permissive film includes second micro-lenses, a second light incident surface, and a second light illuminating surface opposite to the second light incident surface. The second micro-lenses are two dimensionally arranged to form a second micro-lens array. The second light incident surface faces the first light illuminating surface. The first micro-lens array and the second micro-lens array correspondingly produce the moiré pattern effect to provide an image magnification effect.

### CROSS-REFERENCES TO RELATED APPLICATIONS

This non-provisional application claims priority under 35 U.S.C. § 119(a) to Patent Application No. 201910689472.5 filed in China, P.R.C. on Jul. 29, 2019 and to Patent Application No. 108137565 filed in Taiwan, R.O.C. on Oct. 17, 2019, the entire contents of which are hereby incorporated by reference.

### BACKGROUND

### Technical Field

This disclosure relates to an optical lens device, in particular, to a thin film optical lens device.

### Related Art

Along with the rapid developments of multimedia technologies, many electronic devices (e.g., smart phones, tablet computers, notebook computers, or digital cameras) are provided with optical lenses. The optical lenses may be wide-angle lenses, fish-eye lenses, zoom lenses, or the like, so that the electronic devices with optical camera lenses are capable of implementing functions of photographing, web video meeting, face recognition, or the like.

### SUMMARY

However, it is understood that, most of the optical camera lenses known to the inventor are formed by the assembly of several optical lenses, and the optical lenses may be, convex lenses, concave lenses, or the like. As a result, the thickness of the optical camera lens cannot be further reduced. For example, the thickness of the optical lens for smart phones and tablet computers usually exceeds 5 mm, and the thickness of the optical camera lens for digital cameras usually exceeds 50 mm, which is not helpful in the thinning development of the electronic devices.

In view of these, in one embodiment, a thin film optical lens device is provided. The thin film optical lens device comprises a first light-permissive film and a second light-permissive film. The first light-permissive comprises a plurality of first micro-lenses, a first light incident surface, and a first light illuminating surface opposite to the first light incident surface. The first micro-lenses are disposed on the first light incident surface, or on the first light illuminating surface, or on both the first light incident surface and the first light illuminating surface. The first micro-lenses are two-dimensionally arranged to form a first micro-lens array. The second light-permissive film comprises a plurality of second micro-lenses, a second light incident surface, and a second light illuminating surface opposite to the second light incident surface. The second micro-lenses are disposed on the second light incident surface, on the second light illuminating surface, or on both the second light incident surface and the second light illuminating surface. The second micro-lenses are two dimensionally arranged to form a second micro-lens array. The second light incident surface faces the first light illuminating surface. The first micro-lens array and the second micro-lens array correspondingly produce the moiré pattern effect to provide an image magnification effect.

In another embodiment, a thin film optical lens device is provided. The thin film optical lens device comprises a first light-permissive film and a second light-permissive film. The first light-permissive film comprises a plurality of first micro-lenses, a first light incident surface, and a first light illuminating surface opposite to the first light incident surface. The first micro-lenses are disposed on the first light incident surface, on the first light illuminating surface, or on both the first light incident surface and the first light illuminating surface. The first micro-lenses are two-dimensionally arranged to form a first micro-lens array, and the first micro-lenses have a first arrangement interval. The second light-permissive film comprises a plurality of second micro-lenses, a second light incident surface, and a second light illuminating surface opposite to the second light incident surface. The second micro-lenses are disposed on the second light incident surface, on the second light illuminating surface, or on both the second light incident surface and the second light illuminating surface. The second micro-lenses are two-dimensionally arranged to form a second micro-lens array, and the second micro-lenses have a second arrangement interval. The second light incident surface is adjacent to and faces the first light illuminating surface, the second micro-lens array corresponds to the first micro-lens array, and the first arrangement interval is different from the second arrangement interval.

In yet another embodiment, a thin film optical lens device is provided. The thin film optical lens device comprises a first carrier, a second carrier, and a driving member. The first carrier loads a first light-permissive film. The first light-permissive film comprises a plurality of first micro-lenses, a first light incident surface, and a first light illuminating surface opposite to the first light incident surface. The first micro-lenses are disposed on the first light incident surface, on the first light illuminating surface, or on both the first light incident surface and the first light illuminating surface. The first micro-lenses are two-dimensionally arranged to form a first micro-lens array. The second carrier loads a second light-permissive film. The second light-permissive film comprises a plurality of second micro-lenses, a second light incident surface, and a second light illuminating surface opposite to the second light incident surface. The second micro-lenses are disposed on the second light incident surface, on the second light illuminating surface, or on both the second light incident surface and the second light illuminating surface. The second micro-lenses are two-dimensionally arranged to form a second micro-lens array. The second light incident surface is adjacent to and faces the first light illuminating surface, and the second micro-lens array corresponds to the first micro-lens array. The driving member is connected to the second carrier, and the driving member is capable of driving the second carrier to allow the second light-permissive film having a relative motion with respect to the first light-permissive film.

According to one or some embodiments of the instant disclosure, by disposing the first micro-lens array on the first light-permissive film and disposing the second micro-lens array on the second light-permissive film, the first micro-lens array and the second micro-lens array correspondingly produce the moiré pattern effect when the first light-permissive film and the second light-permissive film have a relative motion with respect to each other or when the first light-permissive film and the second light-permissive film have different arrangement intervals. Hence, an image magnification effect can be provided. Accordingly, the thickness of the thin film optical lens device can be greatly reduced. For instance, the thickness of the first light-permissive film and the thickness of the second light-permissive film can be configured in the range between 5 μm and 1000 μm which is apparently less than the thickness of the optical camera lens known to the inventor. It is understood that the thickness range of the first light-permissive film and the second light-permissive film is provided for illustrative example, but not limitations; the thicknesses of the first light-permissive film and the second light-permissive film can be altered according to the products the thin film optical lens device applies to.

### BRIEF DESCRIPTION OF THE DRAWINGS

The disclosure will become more fully understood from the detailed description given herein below for illustration only, and thus not limitative of the disclosure, wherein:

FIG. 1 illustrates a perspective view of a thin film optical lens device according to an exemplary embodiment of the instant disclosure;

FIG. 2 illustrates an exploded view of the thin film optical lens device of the exemplary embodiment;

FIG. 3 illustrates an exploded view of a first light-permissive film and a second light-permissive film according to an exemplary embodiment of the instant disclosure;

FIG. 4 illustrates a schematic exploded view of the thin film optical lens device of the exemplary embodiment;

FIG. 5 illustrates an exemplary imaging view for the thin film optical lens device of the exemplary embodiment;

FIG. 6 illustrates a schematic view of the thin film optical lens device of the exemplary embodiment where optical paths in the device are shown;

FIG. 7 illustrates a plan schematic view of the first light-permissive film and the second light-permissive film according to another exemplary embodiment of the instant disclosure;

FIG. 8 illustrates an exemplary imaging view for the thin film optical lens device shown in FIG. 7;

FIG. 9 illustrates a plan schematic view of the first light-permissive film and the second light-permissive film according to yet another exemplary embodiment of the instant disclosure;

FIG. 10 illustrates a first exemplary imaging view for the thin film optical lens device shown in FIG. 9;

FIG. 11 illustrates a second exemplary imaging view for the thin film optical lens device shown in FIG. 9;

FIG. 12 illustrates a third exemplary imaging view for the thin film optical lens device shown in FIG. 9;

FIG. 13 illustrates a fourth exemplary imaging view for the thin film optical lens device shown in FIG. 9;

FIG. 14 illustrates a fifth exemplary imaging view for the thin film optical lens device shown in FIG. 9;

FIG. 15 illustrates a sixth exemplary imaging view for the thin film optical lens device shown in FIG. 9;

FIG. 16 illustrates a plan view of a thin film optical lens device according to another embodiment of the instant disclosure; and

FIG. 17 illustrates a plan view of a thin film optical lens device according to yet another embodiment of the instant disclosure.

### DETAILED DESCRIPTION

Embodiments are provided for facilitating the descriptions of the instant disclosure. However, the embodiments are provided as examples for illustrative purpose, but not a limitation to the instant disclosure. Moreover, some details may be omitted in the drawings for the sake of clarity for the drawings. In all the figures, same reference numbers designate identical or similar elements.

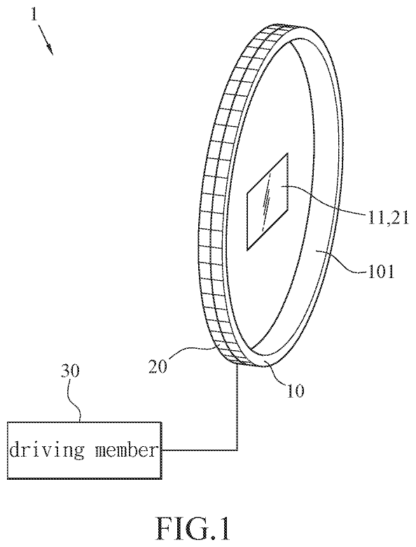

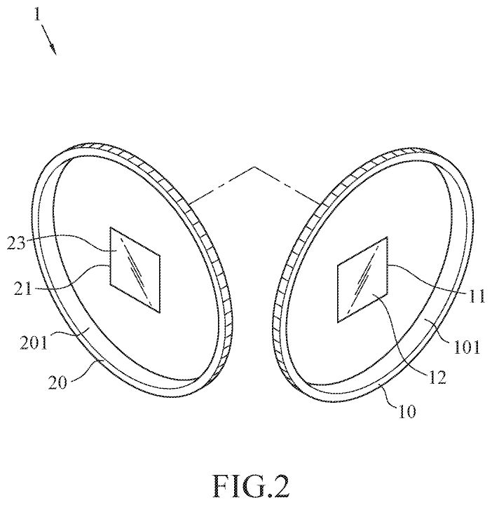

As shown in FIGS. 1 to 3, according to one embodiment of the instant disclosure, the thin film optical lens device may be applied to different electronic devices (e.g., smart phones, tablet computers, notebook computers, digital cameras, or lightening devices). The thin film optical lens device 1 comprises a first light-permissive film 11 and a second light-permissive film 21. The first light-permissive film 11 comprises a first micro-lens array MLA1, and the second light-permissive film 21 comprises a second micro-lens array MLA2. The first micro-lens array MLA1 and the second micro-lens array MLA2 correspondingly produce the moiré pattern effect to provide an imaging or light magnification effect. For instance, the first micro-lens array MLA1 and the second micro-lens array MLA2 can produce the moiré pattern effect through several ways, such as, having different arrangement intervals between the first micro-lens array MLA1 and the second micro-lens array MLA2, maintaining a certain distance between the first micro-lens array MLA1 and the second micro-lens array MLA2, having a certain angle between the first micro-lens array MLA1 and the second micro-lens array MLA2, or having a relative motion between the first micro-lens array MLA1 and the second micro-lens array MLA2. Details for the configurations are provided below.

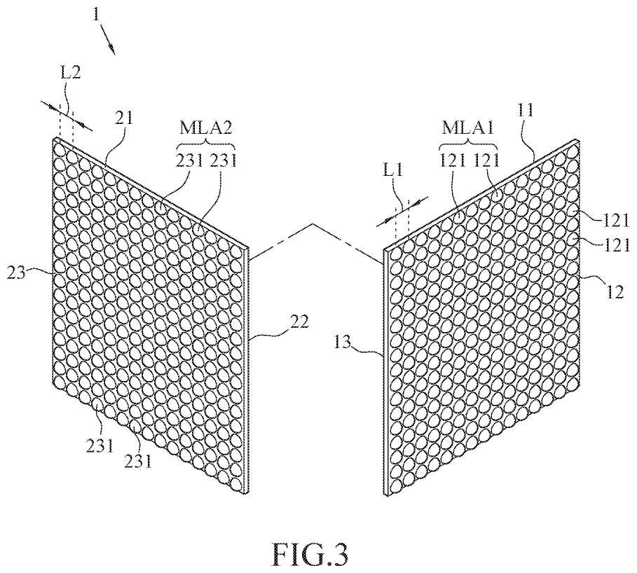

As shown in FIG. 3, the first light-permissive film 11 is a film made of light permissive material(s). For example, the light permissive material may be polycarbonate (PC) or poly(methyl methacrylate) (PMMA). The thickness of the first light-permissive film 11 may be, but not limited to, in the range between 5 μm and 1000 μm. The first light-permissive film 11 comprises two opposite surfaces (namely, a first light incident surface 12 and a first light illuminating surface 13). The first light incident surface 12 is used for receiving the light from outside (e.g., the object light). A plurality of first micro-lenses 121 is disposed on the first light incident surface 12, and the first micro-lenses 121 are two-dimensionally arranged on the first light incident surface 12 to form the first micro-lens array (MLA) MLA1. In some embodiments, the first micro-lenses 121 may be disposed on the first light illuminating surface 13 or on both the first light incident surface 12 and the first light illuminating surface 13.

As shown in FIG. 3, in some embodiments, the size of each of the first micro-lenses 121 of the first micro-lens array MLA1 may be in the range between 2 μm and 2000 μm. Each of the first micro-lenses 121 may be made of transparent material(s), for example, may be made of fused silica, optical glass, or transparent plastic. Each of the first micro-lenses 121 may be a cylindrical lens, a concave lens, a convex lens, or optical lenses in other types. For example, in the embodiment shown in FIG. 3, the shape of each of the first micro-lenses 121 is a convex lens, so that the first micro-lenses 121 protrude out of the first light incident surface 12. The first micro-lenses 121 of the first micro-lens array MLA1 have a first arrangement interval L1. The first arrangement interval L1 may be the distance between adjacent two first micro-lenses 121 of the first micro-lenses 121, or the first arrangement interval L1 may be adjacent two first micro-lenses 121 of the same row or the same column of the first micro-lens array MLA1. In some embodiments, the first arrangement interval L1 may be in the range between 2 μm and 2000 μm, but embodiments are not limited thereto. It is understood that, the first micro-lenses 121 of the first micro-lens array MLA1 may be integrally formed with the first light-permissive film 11, or the first micro-lenses 121 may be formed on the first light incident surface 12 through other processing techniques. The techniques may be screen printing, relief casting, photoresist reflow, micro injection molding, hot embossing, or the like.

As shown in FIG. 3, the second light-permissive film 21 may be made of light permissive material(s) as well, for example, the light permissive material 21 may be polycarbonate or poly(methyl methacrylate). The thickness of the second light-permissive film 21 may be, but not limited to, in the range between 5 μm and 1000 μm. The second light-permissive film 21 comprises two opposite surfaces (namely, a second light incident surface 22 and a second light illuminating surface 23). The first light-permissive film 11 and the second light-permissive film 21 are stacked with each other, and the second light incident surface 22 is adjacent to and faces the first light incident surface 13 of the first light-permissive film 11. A plurality of second micro-lenses 231 is disposed on the second light illuminating surface 23 of the second light-permissive film 23. The second micro-lenses 231 are two dimensionally arranged on the second light illuminating surface 23 to form the second micro-lens array MLA2. In some embodiments, the second micro-lenses 231 may be disposed on the second light incident surface 22 or on both the second light incident surface 22 and the second light illuminating surface 23.

As shown in FIG. 3, in some embodiments, the size of each of the second micro-lenses 231 of the second micro-lens array MLA2 may be in the range between 2 μm and 2000 μm. Each of the second micro-lenses 231 may be made of transparent material(s), for example, may be made of fused silica, optical glass, or transparent plastic. Each of the second micro-lenses 231 may be a cylindrical lens, a concave lens, a convex lens, or optical lenses in other types. For example, in the embodiment shown in FIG. 3, the shape of each of the second micro-lenses 231 is a convex lens, so that the second micro-lenses 231 protrude out of the second light illuminating surface 21. The second micro-lenses 231 of the second micro-lens array MLA2 have a second arrangement interval L2. The second arrangement interval L2 may be the distance between adjacent two second micro-lenses 231 of the second micro-lenses 231, or the second arrangement interval L2 may be adjacent two second micro-lenses 231 of the same row or the same column of the second micro-lens array MLA2. In some embodiments, the second arrangement interval L2 may be in the range between 2 μm and 2000 μm, but embodiments are not limited thereto. It is understood that, the second micro-lenses 231 of the second micro-lens array MLA2 may be integrally formed with the second light-permissive film 21, or the second micro-lenses 231 may be formed on the second light illuminating surface 23 through other processing techniques. The techniques may be screen printing, relief casting, photoresist reflow, micro injection molding, hot embossing, or the like. Moreover, it is understood that, the thickness ranges of the first light-permissive film 11 and the second light-permissive film 21, the size ranges of each of the first micro-lenses 121 and each of the second micro-lenses 231, and the arrangement interval ranges of the first arrangement interval L1 and the second arrangement interval L2 are provided as illustrative purposes, embodiments are not limited thereto; these ranges can be determined according to the products the thin film optical lens device 1 applies to.

As shown in FIG. 3, the first micro-lens array MLA1 on the first light incident surface 12 of the first light-permissive film 11 corresponds to the second micro-lens array MLA2 on the second light illuminating surface 23 of the second light-permissive film 21. For example, in this embodiment, the first light-permissive film 11 and the second light-permissive film 21 have the same size and are aligned along the same axis. Therefore, the first micro-lens array MLA1 and the second micro-lens array MLA2 are aligned along the same axis and correspond to each other.

As shown in FIG. 5, after the first light-permissive film 11 and the second light-permissive film 21 are stacked with each other, a certain angle 0 is between the first light-permissive film 11 and the second light-permissive film 21, so that the first micro-lens array MLA1 and the second micro-lens array MLA2 correspondingly produce the moiré pattern effect. Alternatively, the second light-permissive film 21 may be rotated with respect to the first light-permissive film 11 through mechanical driving, so that the certain angle θ is configured between the first light-permissive film 11 and the second light-permissive film 21. Accordingly, the first micro-lens array MLA1 and the second micro-lens array MLA2 can correspondingly produce the moiré pattern effect. Details for the configurations are provided below.

As shown in FIGS. 1 to 3, the first light-permissive film 11 may be loaded on a first carrier 10. The first carrier 10 may be any substrates capable of loading the first light-permissive film 11. For example, in this embodiment, the first carrier 10 is an annular substrate and has a first hollow portion 101, and the first light-permissive film 11 is disposed in the first hollow portion 101. It is understood that, the described configuration of the first carrier 10 is provided as illustrative embodiments, but not limitations of the instant disclosure. In some embodiments, the first carrier 10 may be substrates in other shapes (e.g., bar-shaped or rectangular-shaped). The second light-permissive film 21 may be loaded on a second carrier 20. The second carrier 20 may be any substrates capable of loading the second light-permissive film 21. For example, in this embodiment, the second carrier 20 is an annular substrate and has a second hollow portion 201, and the second light-permissive film 21 is disposed in the second hollow portion 201. It is understood that, the described configuration of the second carrier 20 is provided as illustrative embodiments, but not limitations of the instant disclosure. In some embodiments, the second carrier 20 may be substrates in other shapes (e.g., bar-shaped or rectangular-shaped).

Further, as shown in FIG. 1, the second carrier 20 is connected to a driving member 30. The driving member 30 is used for driving the second carrier 20 to operate to drive the second light-permissive film 21 to have a relative motion with respect to the first light-permissive film 11. In some embodiments, the driving member 30 may comprise a driving motor, and a transmission mechanism corresponding to the driving motor may be provided between the driving member 30 and the second carrier 20. For example, the transmission mechanism may be a gear transmission mechanism, a worm gear/worm mechanism, or a cam mechanism, and the transmission mechanism is connected to the driving motor. Therefore, through the driving motor and the transmission mechanism, the second carrier 20 can be driven to operate to drive the second light-permissive film 21 to have a relative motion (such as a rotational motion, a leaving motion, an approaching motion, or other relative motions) with respect to the first light-permissive film 11.

According to one or some embodiments of the instant disclosure, the first light-permissive film 11 and the second light-permissive film 21 of the thin film optical lens device 1 can have a relative motion, so that the first micro-lens array MLA1 and the second micro-lens array MLA2 produce the moiré pattern effect. Hence, an image magnification effect can be provided. Details for the configurations are provided below along with descriptions of the drawings.

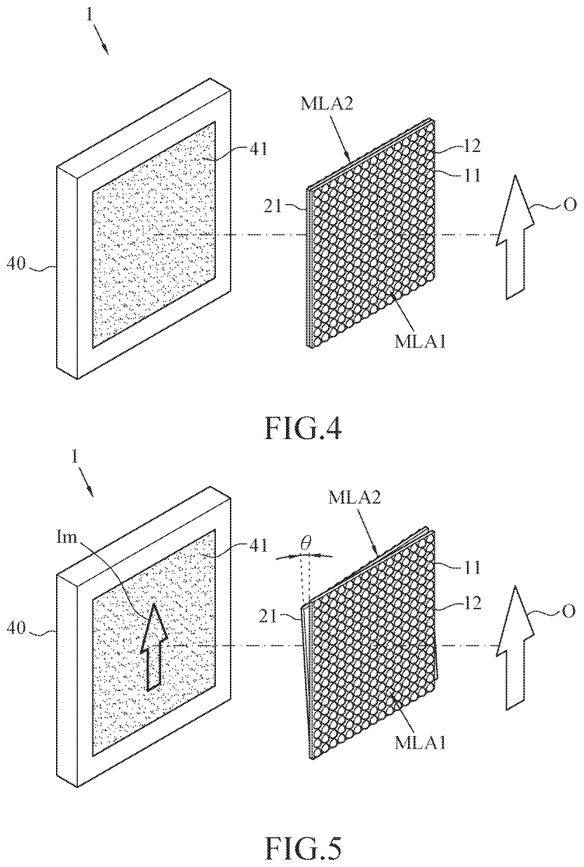

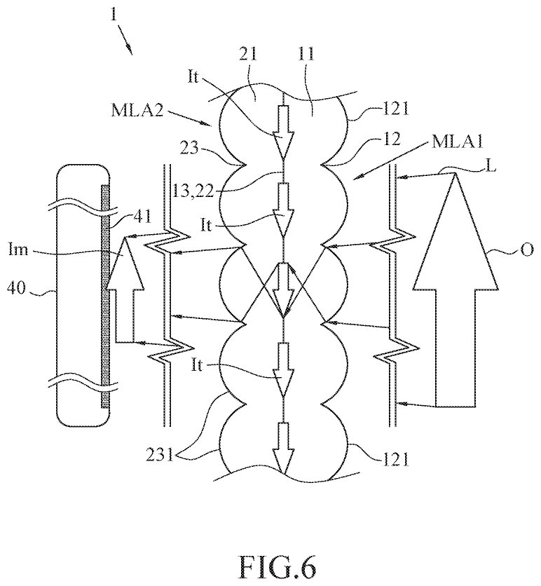

As shown in FIGS. 1 to 6, in this embodiment, the thin film optical lens device 1 comprises a light sensor 40. The light sensor 40 has a light receiving portion 41. The light receiving portion 41 of the light sensor 40 faces the second light illuminating surface 23 of the second light-permissive film 21. The light sensor 40 may be a light sensing element. For example, the light sensor 40 may be a charged-coupled device (CCD), a complementary metal-oxide semiconductor (CMOS), or a CMOS active pixel sensor.

As mentioned above, in this embodiment, the size of each of the first micro-lenses 121 of the first micro-lens array MLA1 is the same as the size of each of the second micro-lenses 231 of the second micro-lens array MLA2, and the arrangement interval L1 of the first micro-lenses 121 of the first micro-lens array MLA1 is the same as the arrangement interval L2 of the second micro-lenses 231 of the second micro-lens array MLA2. Accordingly, the first micro-lenses 121 of the first micro-lens array MLA1 respectively correspond to the second micro-lenses 231 of the second micro-lens array MLA2.

As shown in FIGS. 1 to 6, in the thin film optical lens device 1, during the image-photographing process or the image-capturing process, the object light L produced by an external object O can enter into the first light-permissive film 11 from the first light incident surface 12 of the first light-permissive film 11. Because the first light incident surface 12 comprises the first micro-lenses 121, the first light illuminating surface 13 of the first light-permissive film 11 forms several upside-down small images It corresponding to the external object O, and the upside-down small images It respectively correspond to the first micro-lenses 121. As shown in FIGS. 1, 5, and 6, after the driving member 30 drives the second carrier 20 to drive the second light-permissive film 21 to rotate about a certain angle (e.g., 0.1, 1, or 2 degrees) with respect to the first light-permissive film 11, the first micro-lens array MLA1 of the first light-permissive film 11 and the second micro-lens array MLA2 of the second permissive film 21 correspondingly produce the moiré pattern effect. Therefore, when the object light L enters into the second light-permissive film 21 from the second incident surface 22 of the second light-permissive film 21 and exits out of the second light-permissive film 21 from the second light illuminating surface 23 so as to be transmitted to the light receiving portion 41 of the light sensor 40, the upside-down small image It produced by one of the first micro-lenses 121 can be magnified through the moiré pattern effect to be imaged on the light sensor 40, so that a moiré pattern magnified image Im corresponding to the external object O can be formed on the light sensor 40. In other words, the moiré pattern magnified image Im is an enlarged image which corresponds to the external object O, and the enlarged image is formed when the object light L enters into the first light-permissive film 11 from the first incident surface 12, exits from the second illuminating surface 23 of the second light-permissive film 21 through the moiré pattern effect, and illuminates on the light receiving portion 41 of the light sensor 40.

Based on the above, according to one or some embodiments of the instant disclosure, the thickness of the thin film optical lens device 1 can be greatly reduced. For instance, the thickness of the first light-permissive film 11 and the thickness of the second light-permissive film 21 can be configured in the range between 5 μm and 1000 μm which is apparently less than the thickness of the optical camera lens known to the inventor. Moreover, through the moiré pattern effect produced by the first micro-lens array MLA1 and the second micro-lens array MLA2, the thin film optical lens device 1 can provide not only the image-photographing function but also the image-capturing function.

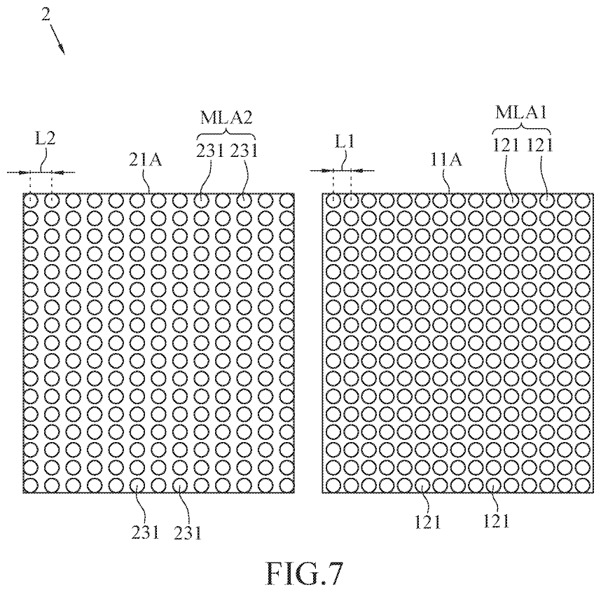

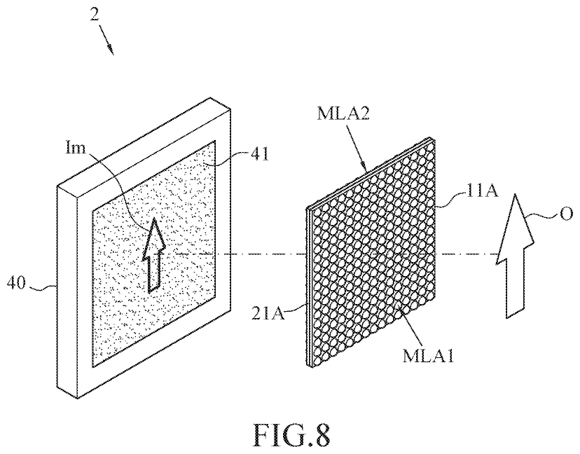

As shown in FIG. 7, FIG. 7 illustrates a plan schematic view of a first light-permissive film 11A and a second light-permissive film 21A according to another exemplary embodiment of the instant disclosure. One difference between this embodiment and the embodiment shown in FIG. 3 is that, as shown in the thin film optical lens device 2 of this embodiment, the first arrangement interval L1 of the first micro-lenses 121 of the first micro-lens array MLA1 on the first light-permissive film 11A is different from the second arrangement interval L2 of the second micro-lenses 231 of the second micro-lens array MLA2 on the second light-permissive film 21A. In this embodiment, the second arrangement interval L2 is greater than the first arrangement interval L1. Accordingly, as shown in FIG. 8, because the first arrangement interval L1 is different from the second arrangement interval L2, the first micro-lens array MLA1 and the second micro-lens array MLA2 can produce the moiré pattern effect without having a relative motion. Hence, a moiré pattern magnified image Im with a constant magnification corresponding to the external object O can be formed on the light sensor 40 without using the driving member 30, thereby reducing the manufacturing cost for the device.

Further, as shown in FIGS. 7 and 8, the thin film optical lens device 2 in this embodiment may also comprise the driving member 30, and the driving member 30 drives the second carrier 20 to drive the second light-permissive film 21A to have a relative motion (e.g., a rotational motion, a leaving motion, or an approaching motion) with respect to the first light-permissive film 11A. Hence, the first micro-lens array MLA1 and the second micro-lens array MLA2 can produce different moiré pattern effects, so that moiré pattern magnified images Im with different magnifications can be formed on the light sensor 40.

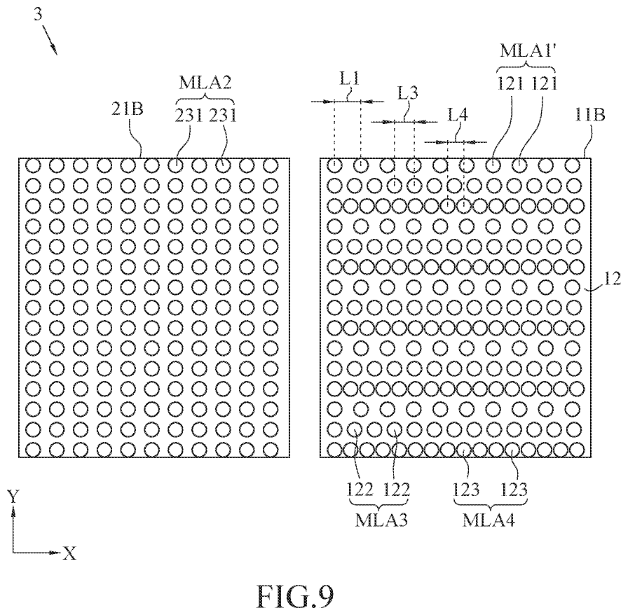

As shown in FIG. 9, FIG. 9 illustrates a plan schematic view of a first light-permissive film 11B and a second light-permissive film 21B according to yet another exemplary embodiment of the instant disclosure. One difference between this embodiment and the embodiments shown in FIGS. 3 and 7 is that, as shown in the thin film optical lens device 3 of this embodiment, the first light incident surface 12 of the first light-permissive film 11B comprises several micro-lens arrays with different arrangement intervals (in this embodiment, a first micro-lens array MLA1′, a third micro-lens array MLA3, and a fourth micro-lens array MLA4). The configuration of the second micro-lens array MLA2 of the second light-permissive film 21B may be the same as that of the second light-permissive films 21, 21A. The second micro-lenses 231 are spaced equidistantly. In this embodiment, the first micro-lens array MLA1 of the first light-permissive film 11B comprises a plurality of rows of first micro-lenses 121. Each row of the first micro-lenses 121 is arranged horizontally along the X-axis direction shown in the figure (in this embodiment, the first micro-lens array MLA1′ is formed by the first micro-lenses 121 at the first row, the fourth row, the seventh row, the tenth row, the thirteenth row, and the sixteenth row on the first light-permissive film 11B). In this embodiment, the third micro-lens array MLA3 comprises a plurality of rows of third micro-lenses 122. Each row of the third micro-lenses 122 is arranged horizontally along the X-axis direction shown in the figure. The third micro-lenses 122 and the first micro-lenses 121 are alternately arranged on the first light-permissive film 11B (in this embodiment, the third micro-lens array MLA3 is formed by the third micro-lenses 122 at the second row, the fifth row, the eighth row, the eleventh row, and the fourteenth row on the first light-permissive film 11B). In this embodiment, the fourth micro-lens array MLA4 comprises a plurality of rows of fourth micro-lenses 123. Each row of the fourth micro-lenses 123 is arranged horizontally along the X-axis direction shown in the figure. The fourth micro-lenses 123, the third micro-lenses 122, and the first micro-lenses 121 are alternately arranged on the first light-permissive film 11B (in this embodiment, the fourth micro-lens array MLA4 is formed by the fourth micro-lenses 123 at the third row, the sixth row, the ninth row, the twelfth row, and the fifteenth row on the first light-permissive film 11B).

The first micro-lenses 121 of the first micro-lens array MLA1′ have a first arrangement interval L1. In this embodiment, the first arrangement interval L1 indicates the horizontal distance between adjacent two first micro-lenses 121 of the first micro-lenses 121 in the same row. The third micro-lenses 122 of the third micro-lens array MLA3 have a third arrangement interval L3. In this embodiment, the third arrangement interval L3 indicates the horizontal distance between adjacent two third micro-lenses 122 of the third micro-lenses 122 in the same row. The fourth micro-lenses 123 of the fourth micro-lens array MLA4 have a fourth arrangement interval L4. In this embodiment, the fourth arrangement interval L4 indicates the horizontal distance between adjacent two fourth micro-lenses 123 of the fourth micro-lenses 123 in the same row. Moreover, the first arrangement interval L1, the third arrangement interval L3, and the fourth arrangement interval L4 are different from each other. For example, in this embodiment, the first arrangement interval L1 is greater than the third arrangement interval L3, and the third arrangement interval L3 is greater than the fourth arrangement interval L4. Therefore, the first micro-lens array MLA1′, the third micro-lens array MLA3, and the fourth micro-lens array MLA4 can provide different optical effects (e.g., the first micro-lens array MLA1′ can provide a telephoto lens performance, the third micro-lens array MLA3 can provide a standard lens performance, and the fourth micro-lens array MLA4 can provide a microscope lens performance).

Accordingly, when the driving member 30 drives the second carrier 20 to drive the second light-permissive film 21B to have a relative motion with respect to the first light-permissive film 11B, the second micro-lens array MLA2 of the second light-permissive film 21B respectively corresponds to the first micro-lens array MLA1′, the third micro-lens array MLA3, and the fourth micro-lens array MLA4 with different arrangement intervals to provide different optical magnification effects. Details for the configurations are provided below along with descriptions of the drawings.

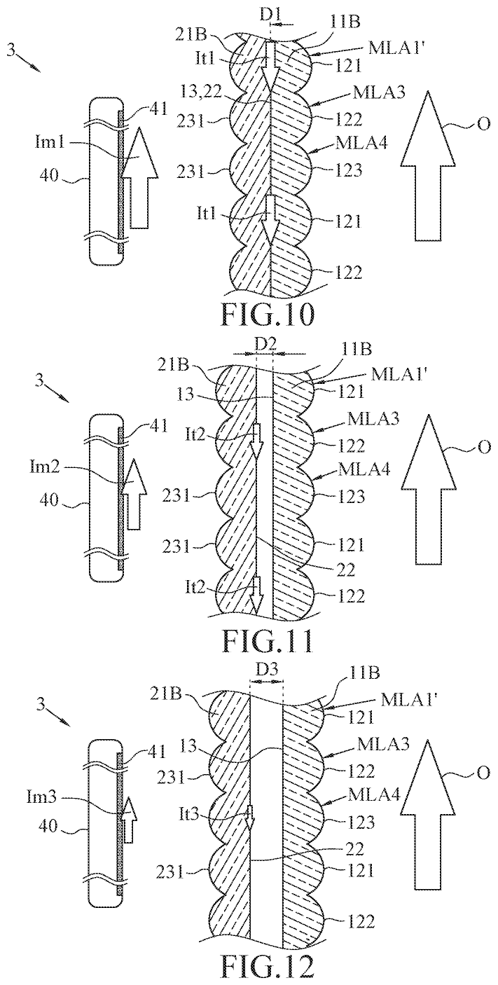

As shown in FIGS. 9 to 13, the second light-permissive film 21B can have a leaving motion or an approaching motion with respect to the first light-permissive film 11B to respectively correspond to the first micro-lens array MLA1′, the third micro-lens array MLA3, and the fourth micro-lens array MLA4 with different arrangement intervals. As shown in FIG. 10, when the second light-permissive film 21B moves toward the first light-permissive film 11B to allow the second light incident surface 22 of the second light-permissive film 21B to attach on the first light illuminating surface 13 of the first light-permissive film 11B, the distance between the first light-permissive film 11B and the second light-permissive film 21B is D1 and corresponds to the focal point of the first micro-lens array MLA1′. Therefore, the second micro-lens array MLA2 and the first micro-lens array MLA1′ can produce the moiré pattern effect. Hence, a first upside-down small image It1 produced by one of the first micro-lenses 121 can be magnified through the moiré pattern effect to be imaged on the light sensor 40, and a first moiré pattern magnified image Im1 with a first magnification corresponding to the external object O can be formed on the light sensor 40. As shown in FIG. 11, when the second light-permissive film 21B moves away from the first light-permissive film 11B, the distance between the second light incident surface 22 of the second light-permissive film 21B and the first light illuminating surface 13 of the first light-permissive film 11B is D2 and corresponds to the focal point of the third micro-lens array MLA3. Therefore, the second micro-lens array MLA2 and the third micro-lens array MLA3 can produce the moiré pattern effect. Hence, a second upside-down small image It2 produced by one of the third micro-lenses 122 can be magnified through the moiré pattern effect to be imaged on the light sensor 40, and a second moiré pattern magnified image Im2 with a second magnification corresponding to the external object O can be formed on the light sensor 40. Because the first arrangement interval L1 of the first micro-lens array MLA1′ is different from the third arrangement interval L3 of the third micro-lens array MLA3, the first micro-lens array MLA1′ and the third micro-lens array MLA3 produce different image magnification effects. Therefore, the first magnification of the first moiré pattern magnified image Im1 is different from the second magnification of the second moiré pattern magnified image Im2. In this embodiment, the first moiré pattern magnified image Im1 is larger than the second moiré pattern magnified image Im2. As shown in FIG. 12, when the second light-permissive film 21B moves away from the first light-permissive film 11B again, the distance between the second light incident surface 22 of the second light-permissive film 21B and the first light illuminating surface 13 of the first light-permissive film 11B is D3 and corresponds to the focal point of the fourth micro-lens array MLA4. Therefore, the second micro-lens array MLA2 and the fourth micro-lens array MLA4 can produce the moiré pattern effect. Hence, a third upside-down small image It3 produced by one of the fourth micro-lenses 123 can be magnified through the moiré pattern effect to be imaged on the light sensor 40, and a third moiré pattern magnified image Im3 with a third magnification corresponding to the external object O can be formed on the light sensor 40. Because the first arrangement interval L1 of the first micro-lens array MLA1′, the third arrangement interval L3 of the third micro-lens array MLA3, and the fourth arrangement interval L4 of the fourth micro-lens array MLA4 are different from each other, the first micro-lens array MLA1′, the third micro-lens array MLA3, and the fourth micro-lens array MLA4 produce different image magnification effects. Therefore, the first magnification of the first moiré pattern magnified image Im1, the second magnification of the second moiré pattern magnified image Im2, and the third magnification of the third moiré pattern magnified image Im3 are different from each other. In this embodiment, the first moiré pattern magnified image Im1 is larger than the second moiré pattern magnified image Im2, and the second moiré pattern magnified image Im2 is larger than the third moiré pattern magnified image Im3. Accordingly, based on one or some embodiments of the instant disclosure, since the first light incident surface 12 of the first light-permissive film 11B has micro-lens arrays with different arrangement intervals, optical magnification effects (e.g., telescope, standard, or microscope) with different magnifications can be provided using the same thin film optical lens device 3.

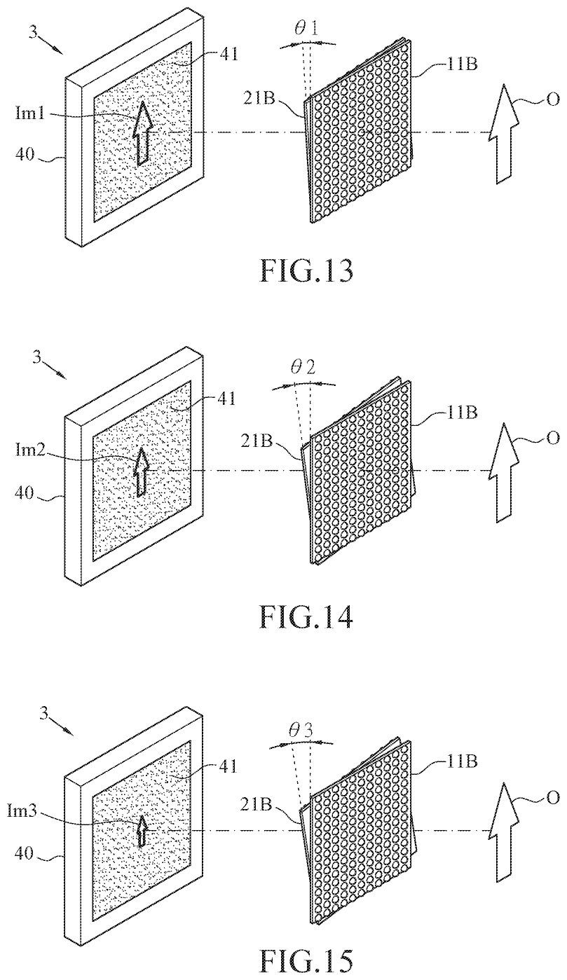

As shown in FIGS. 13 to 15, alternatively, the second light-permissive film 21B may have a rotational motion with respect to the first light-permissive film 11B so as to respectively correspond to the first micro-lens array MLA1′, the third micro-lens array MLA3, and the fourth micro-lens array MLA4 with different arrangement intervals. As shown in FIG. 13, when the second light-permissive film 21B rotates about a first angle 01 (e.g., the first angle θ1 is 0.1 degree) with respect to the first light-permissive film 11B, the second micro-lens array MLA2 and the first micro-lens array MLA1′ can produce the moiré pattern effect. Therefore, the first moiré pattern magnified image Im1 with the first magnification corresponding to the external object O can be formed on the light sensor 40. As shown in FIG. 14, when the second light-permissive film 21B rotates about a second angle θ2 (e.g., the second angle θ2 is 1 degree) with respect to the first light-permissive film 11B, the second micro-lens array MLA2 and the third micro-lens array MLA3 can produce the moiré pattern effect. Therefore, the second moiré pattern magnified image Im2 with the second magnification corresponding to the external object O can be formed on the light sensor 40. As shown in FIG. 15, when the second light-permissive film 21B rotates about a third angle θ3 (e.g., the third angle θ3 is 2 degrees) with respect to the first light-permissive film 11B, the second micro-lens array MLA2 and the fourth micro-lens array MLA4 can produce the moiré pattern effect. Therefore, the third moiré pattern magnified image Im3 with the third magnification corresponding to the external object O can be formed on the light sensor 40. Accordingly, optical magnification effects (e.g., telescope, standard, or microscope) with different magnifications can be provided using the same thin film optical lens device 3.

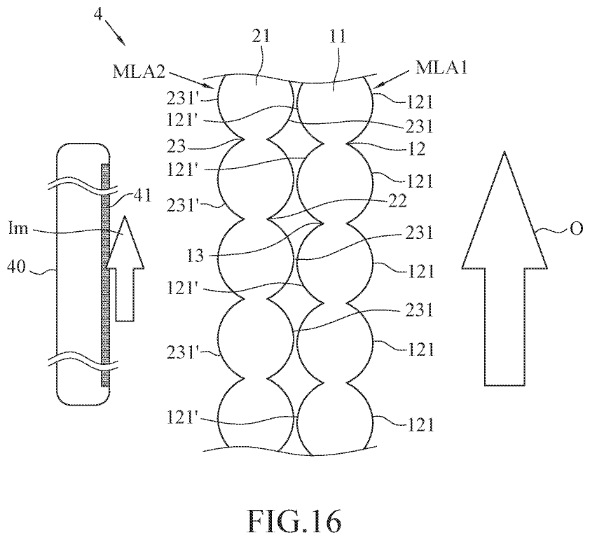

As shown in FIG. 16, FIG. 16 illustrates a plan view of a thin film optical lens device 4 according to another embodiment of the instant disclosure. One difference between this embodiment and the embodiment(s) shown in FIGS. 1 to 6 is that, as shown in the thin film optical lens device 4 of this embodiment, the first light incident surface 12 and the first light illuminating surface 13 of the first light-permissive film 11 comprise first micro-lenses 121, 121′. The first micro-lenses 121 are two-dimensionally arranged on the first light incident surface 12, and the first micro-lenses 121′ are two-dimensionally arranged on the first light illuminating surface 13. The first micro-lenses 121 and the first micro-lenses 121′ correspond to each other to form a first micro-lens array MLA1. Similarly, the second light incident surface 22 and the second light illuminating surface 23 of the second light-permissive film 21 comprise second micro-lenses 231, 231′. The second micro-lenses 231 are two-dimensionally arranged on the second light incident surface 22, and the second micro-lenses 231′ are two-dimensionally arranged on the second light illuminating surface 23. The second micro-lenses 231 and the second micro-lenses 231′ correspond to each other to form a second micro-lens array MLA2. Accordingly, the first micro-lens array MLA1 and the second micro-lens array MLA2 can produce the moiré pattern effect through several ways, such as, having different arrangement intervals between the first micro-lens array MLA1 and the second micro-lens array MLA2, maintaining a certain distance between the first micro-lens array MLA1 and the second micro-lens array MLA2, having a certain angle between the first micro-lens array MLA1 and the second micro-lens array MLA2, or having a relative motion between the first micro-lens array MLA1 and the second micro-lens array MLA2. Details for the configurations are omitted here.

Moreover, as shown in FIG. 16, in this embodiment, the first micro-lenses 121, 121′ and the second micro-lenses 231, 231′ may be, but not limited to, convex lenses. In some embodiments, the first micro-lenses 121, 121′ and the second micro-lenses 231, 231′ may be concave lenses, spherical lenses, aspherical lenses, or the like. Alternatively, the first micro-lenses 121′ 121′ and the second micro-lenses 231, 231′ may be lenses in different types, respectively.

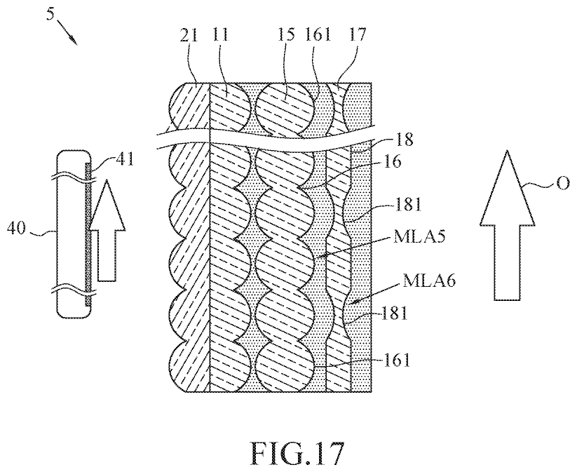

As shown in FIG. 17, FIG. 17 illustrates a plan view of a thin film optical lens device 5 according to yet another embodiment of the instant disclosure. One difference between this embodiment and the embodiment(s) shown in FIGS. 1 to 6 is that, as shown in the thin film optical lens device 5 of this embodiment, the first carrier 10 further loads at least one light-permissive film. In this embodiment, the first carrier 10 loads a third light-permissive film 15 and a fourth light-permissive film 17. The third light-permissive film 15 and the fourth light-permissive film 17 are stacked on the first light-permissive film 11. A surface 16 of the third light-permissive film 15 comprises a plurality of micro-lenses 161 (in this embodiment, the micro-lenses 161 are convex lenses, but may be other optical lenses). The micro-lenses 161 are two-dimensionally arranged on the surface 16 to form a micro-lens array MLA5. A surface 18 of the fourth light-permissive film 17 comprises a plurality of micro-lenses 181 (in this embodiment, the micro-lenses 181 are concave lenses, but may be other optical lenses). The micro-lenses 181 are two-dimensionally arranged on the surface 18 to form a micro-lens array MLA6. It is understood that, the arrangement interval of the micro-lens array MLA5 may be different from the arrangement interval of the micro-lens array MLA6; alternatively, the micro-lens array MLA5 and the micro-lens array MLA6 may have different types of micro-lenses at different rows. Therefore, when the second light-permissive film 21 and the first light-permissive film 11 have a relative motion with each other to produce the moiré pattern effect, different optical magnification effects can be provided.

What is claimed is:

1. A thin film optical lens device, comprising:
a first light-permissive film, comprising a plurality of first micro-lenses, a first light incident surface, and a first light illuminating surface opposite to the first light incident surface; the first micro-lenses are disposed on the first light incident surface, or on the first light illuminating surface, or on both the first light incident surface and the first light illuminating surface; the first micro-lenses are two-dimensionally arranged to form a first micro-lens array; and
a second light-permissive film, comprising a plurality of second micro-lenses, a second light incident surface, and a second light illuminating surface opposite to the second light incident surface; the second micro-lenses are disposed on the second light incident surface, or on the second light illuminating surface, or on both the second light incident surface and the second light illuminating surface; the second micro-lenses are two-dimensionally arranged to form a second micro-lens array; the second light incident surface is adjacent to and faces the first light illuminating surface;
wherein the first micro-lens array and the second micro-lens array correspondingly produce the moiré pattern effect to provide an imaging magnification effect.

2. The thin film optical lens device according to claim 1, wherein the first micro-lenses of the first micro-lens array have a first arrangement interval, the second micro-lenses of the second micro-lens array have a second arrangement interval, the first arrangement interval is different from the second arrangement interval, so that the first micro-lens array and the second micro-lens array correspondingly produce the moiré pattern effect.

3. The thin film optical lens device according to claim 1, wherein a certain distance is between the first light-permissive film and the second light-permissive film, so that the first micro-lens array and the second micro-lens array correspondingly produce the moiré pattern effect.

4. The thin film optical lens device according to claim 1, wherein a certain angle is between the first light-permissive film and the second light-permissive film, so that the first micro-lens array and the second micro-lens array correspondingly produce the moiré pattern effect.

5. The thin film optical lens device according to claim 1, wherein the first light-permissive film and the second light-permissive film have a relative motion with respect to each other, so that the first micro-lens array and the second micro-lens array correspondingly produce the moiré pattern effect.

6. A thin film optical lens device, comprising:
a first light-permissive film, comprising a plurality of first micro-lenses, a first light incident surface, and a first light illuminating surface opposite to the first light incident surface; the first micro-lenses are disposed on the first light incident surface, or on the first light illuminating surface, or on both the first light incident surface and the first light illuminating surface; the first micro-lenses are two-dimensionally arranged to form a first micro-lens array, and the first micro-lenses have a first arrangement interval; and
a second light-permissive film, comprising a plurality of second micro-lenses, a second incident surface, and a second light illuminating surface opposite to the second light incident surface; the second micro-lenses are disposed on the second light incident surface, or on the second light illuminating surface, or on both the second light incident surface and the second light illuminating surface; the second micro-lenses are two-dimensionally arranged to form a second micro-lens array, and the second micro-lenses have a second arrangement interval;
wherein the second light incident surface is adjacent to and faces the first light illuminating surface, the second micro-lens array corresponds to the first micro-lens array, and the first arrangement interval is different from the second arrangement interval.

7. The thin film optical lens device according to claim 6, further comprising a third light-permissive film, wherein the third light-permissive film is stacked on the first light-permissive film, a surface of the third light-permissive film comprises a plurality of micro-lenses, and the micro-lenses are two-dimensionally arranged on the surface to form a micro-lens array.

8. The thin film optical lens device according to claim 6, further comprising a light sensor, wherein the light sensor comprises a light receiving portion, the light receiving portion of the light sensor faces the second light illuminating surface of the second light-permissive film.

9. The thin film optical lens device according to claim 6, further comprising a first carrier and a second carrier, wherein the first carrier loads the first light-permissive film, and the second carrier loads the second light-permissive film.

10. A thin film optical lens device, comprising:
a first carrier loading a first light-permissive film, wherein the first light-permissive film comprises a plurality of first micro-lenses, a first light incident surface, and a first light illuminating surface opposite to the first light incident surface; the first micro-lenses are disposed on the first light incident surface, or on the first light illuminating surface, or on both the first light incident surface and the first light illuminating surface; the first micro-lenses are two-dimensionally arranged to form a first micro-lens array;
a second carrier loading a second light-permissive film, wherein the second light-permissive film comprises a plurality of second micro-lenses, a second incident surface, and a second light illuminating surface opposite to the second light incident surface; the second micro-lenses are disposed on the second light incident surface, or on the second light illuminating surface, or on both the second light incident surface and the second light illuminating surface; the second micro-lenses are two-dimensionally arranged to form a second micro-lens array; wherein the second light incident surface is adjacent to and faces the first light illuminating surface, and the second micro-lens array corresponds to the first micro-lens array; and
a driving member connected to the second carrier, wherein the driving member is capable of driving the second carrier to allow the second light-permissive film having a relative motion with respect to the first light-permissive film.

11. The thin film optical lens device according to claim 10, wherein the first micro-lenses of the first micro-lens array have a first arrangement interval, the second micro-lenses of the second micro-lens array have a second arrangement interval, the first arrangement interval is the same as the second arrangement interval, and the relative motion is a rotational motion.

12. The thin film optical lens device according to claim 10, wherein the first micro-lenses of the first micro-lens array have a first arrangement interval, the second micro-lenses of the second micro-lens array have a second arrangement interval, and the first arrangement interval is different from the second arrangement interval.

13. The thin film optical lens device according to claim 12, wherein the relative motion is a rotational motion.

14. The thin film optical lens device according to claim 12, wherein the relative motion is a leaving motion or an approaching motion.

15. The thin film optical lens device according to claim 10, wherein the first light-permissive film further comprises a plurality of third micro-lenses, the third micro-lenses are disposed on the first light incident surface, or on the first light illuminating surface, or on both the first light incident surface and the first light illuminating surface; the third micro-lenses are two-dimensionally arranged to form a third micro-lens array, and the first arrangement interval is different from the third arrangement interval.

16. The thin film optical lens device according to claim 15, wherein the relative motion is a rotational motion.

17. The thin film optical lens device according to claim 15, wherein the relative motion is a leaving motion or an approaching motion.

18. The thin film optical lens device according to claim 10, wherein the first carrier further loads a third light-permissive film, the third light-permissive film is stacked on the first light-permissive film, a surface of the third light-permissive film comprises a plurality of micro-lenses, and the micro-lenses are two-dimensionally arranged on the surface to form a micro-lens array.

19. The thin film optical lens device according to claim 10, further comprising a light sensor, wherein the light sensor comprises a light receiving portion, the light receiving portion of the light sensor faces the second light illuminating surface of the second light-permissive film.
